(19) United States
(12) Patent Application Publication
(10) Pub. No.: US 2021/0264452 A1
(43) Pub. Date: Aug. 26, 2021

(54) SYSTEMS AND METHODS FOR IDENTIFYING ENTITIES FOR SERVICES BASED ON NETWORK ACTIVITY

(71) Applicant: MASTERCARD INTERNATIONAL INCORPORATED, Purchase, NY (US)

(72) Inventors: Reza Rahimi, Chesterfield, MO (US); Walter F. Lo Faro, St. Louis, MO (US)

(21) Appl. No.: 16/796,379

(22) Filed: Feb. 20, 2020

(51) Int. Cl. G06Q 30/02; G06Q 40/02; G06Q 30/04; G06F 16/23

(52) U.S. Cl. CPC G06Q 30/0205; G06F 16/2379; G06Q 30/04; G06Q 40/02

(57) ABSTRACT

Systems and methods are provided for use in identifying recurring local entities for a target region. One exemplary method includes receiving a request for identifying recurring local entities for a target region and accessing data for the target region for multiple accounts. The data is representative of multiple transactions and multiple accounts, with each transaction having an account number associated with a user and a region identifier associated with an entity involved in the transaction. The method also includes determining a local region for each of the accounts included in the data and, for each determined local region that is the same as the target region, identifying one or more recurring entity from the transactions to said accounts having the determined local region. The method then includes compiling a listing of recurring local entities including the identified one or more recurring entities.

### FIELD

The present disclosure generally relates to systems and methods for use in identifying entities as suited to one or more services based on network activity associated with the entities.

### BACKGROUND

This section provides background information related to the present disclosure which is not necessarily prior art.

Users typically use payment accounts in transactions to fund purchases of products (e.g., good and services, etc.) from merchants. Transaction data, representative of such transactions, is known to be collected and stored in one or more data structures as evidence of the transactions. The transaction data may be stored, for example, by payment networks, issuers, and/or acquirers involved in the transactions. Subsequently, it is known for the payment networks, for example, to use the transaction data as input to services offered by the payment network, such as fraud prevention models.

Separately, it is known for users to set up automatic bill payments for recurring payments to given billers, such as, for example, utility companies, etc. In order to do so, the users access bill payment applications, for example, through their banking institutions, and enter the specific details to the billers and the corresponding bills to setup or register the billers for the users' accounts. Thereafter, the users are permitted to initiate payments, manually or automatically, on given schedules to the billers.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for identifying recurring local billers in target regions, in response to or in connection with network requests related to the target regions and/or billers;

FIG. 2 is a block diagram of a computing device that may be used in the exemplary system of FIG. 1;

FIG. 3 is an exemplary method that may be implemented in connection with the system of FIG. 1 for identifying one or more recurring local billers for a target region, in response to a network request specific to the target region; and

FIG. 4 illustrates an exemplary interface, which may be displayed to a user in connection with the system of FIG. 1 and/or the method of FIG. 3, where the interface includes recurring local billers identified to the user in connection with a bill payment service.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Manual set up of bill pay accounts by users is often difficult because of the lack of specific information about billers (or merchants) (e.g., biller accounts, etc.). For example, the users may be confused about which billers are actually associated with the services being provided to the users, for which the bills are to be paid. As such, because of such confusion or uncertainty (and the related friction associated with initial setup), users may avoid digital payment of bills, including, specifically, recurring bills.

Uniquely, the systems and methods herein permit recurring billers in particular regions (e.g., in regions local to corresponding users associated with the billers, etc.) to be identified to the users, based on transaction data identified to the regions, whereby users in the regions may select from the identified recurring local billers (linked to specific biller account data for the recurring billers) in connection with setting up recurring bill payments, rather than relying entirely on manual entry of the biller account data. Specifically, transaction data that is probabilistically linked to specific regions is identified, and then recurring local transactions associated with the data are identified for the particular regions. When identified, a list of the merchants or billers involved in the recurring transactions is compiled for each of the particular regions, as a list of local recurring billers for the given region. Subsequently, in response to a request for a list of billers for a specific region, the appropriate list of billers may be provided, for example, to a bill pay provider (broadly, an entity), whereby the list may then be provided to a user at the bill pay provider, as billers that are likely to be recurring billers for the user. In this manner, transaction data may be leveraged in a new and particular manner to identify local recurring billers, to thereby enhance and improve electronic (or digital) bill pay services associated with bill pay providers.

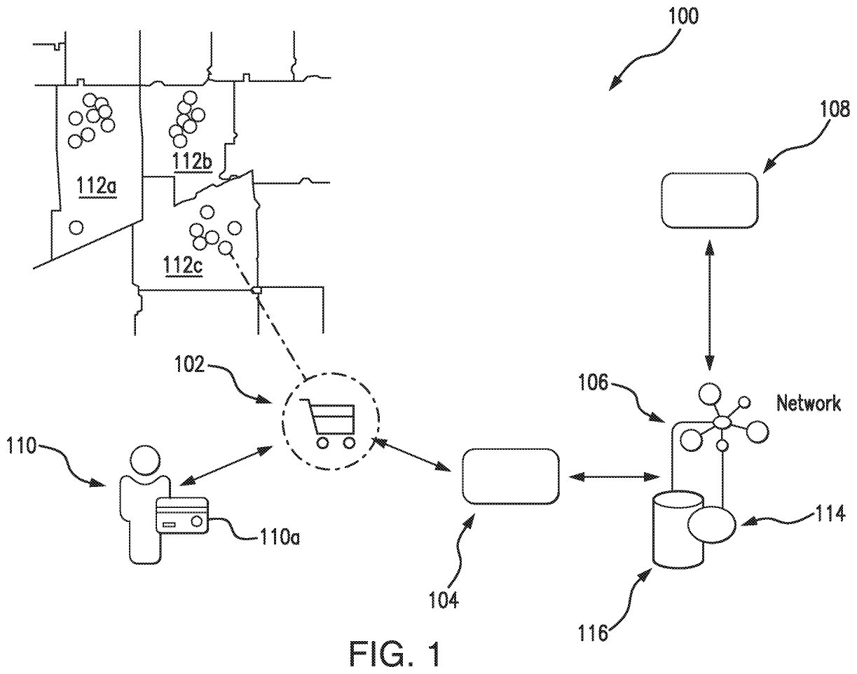

FIG. 1 illustrates an exemplary system 100, in which one or more aspects of the present disclosure may be implemented. Although the system 100 is presented in one arrangement, other embodiments may include systems arranged otherwise depending, for example, on types of transaction data in the systems, types of billers in the systems, privacy requirements, etc.

As shown in FIG. 1, the system 100 generally includes a merchant 102, an acquirer 104, a payment network 106, and an issuer 108, each coupled to (and in communication with) one or more networks, as generally indicated by (or represented by) the arrowed lines. The network(s) may each include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network(s) may each include multiple different networks, such as a private payment transaction network made accessible by the payment network 106 to the acquirer 104 and the issuer 108 and, separately, the public Internet, which may be accessible as desired to the merchant 102, the acquirer 104, a user 110, etc.

The merchant 102 is generally associated with products (e.g., goods and/or services, etc.) for purchase by one or more consumers, for example, via payment accounts. In connection therewith, the merchant 102 may include an online merchant, having a virtual location on the Internet (e.g., a website accessible through one or more of the networks described above, etc.), or a virtual location provided through a web-based application, etc., that permits consumers to initiate transactions for products offered for sale by the merchant 102 remotely, electronically, etc. In addition, or alternatively, the merchant 102 may include at least one brick-and-mortar location, whereby consumers may physically enter the location and initiate transactions for the products. In the description herein, the merchant 102 may also (or alternatively) be referred to, generally, as a biller.

In connection with a purchase of a product by a consumer, such as user 110 shown in FIG. 1, at the merchant 102, via a payment account issued to the user 110 by the issuer 108 (e.g., a credit account, a debit account, a prepaid account, etc.), for example, the user 110 provides one or more credentials to the merchant 102 for his/her payment account (e.g., directly via a payment device 110 a associated with the account or via a virtual wallet, etc.; indirectly via a card-on-file, etc.; etc.). In turn, an authorization request is generated at the merchant 102 and transmitted to the acquirer 104 (via one or more of the networks in FIG. 1). The acquirer 104, in turn, communicates the authorization request to the issuer 108, through the payment network 106, such as, for example, through Mastercard™, VISA™, Discover™, American Express™, etc. (all, broadly payment networks), to determine (in conjunction with the issuer 108 that provided the payment account to the consumer) whether the payment account is in good standing and whether there is sufficient credit/funds to complete the transaction. If the issuer 108 accepts the transaction, a reply authorizing the transaction (e.g., an authorization reply, etc.) is conventionally provided back to the acquirer 104 and the merchant 102, thereby permitting the merchant 102 to complete the transaction. The transaction is later cleared and/or settled by and between the merchant 102 and the acquirer 104 (via an agreement between the merchant 102 and the acquirer 104), and by and between the acquirer 104 and the issuer 108 (via an agreement between the acquirer 104 and the issuer 108), through further communications therebetween (e.g., as facilitated by the payment network 106, etc.). If the issuer 108 declines the transaction for any reason, a reply declining the transaction is instead provided back to the merchant 102, thereby permitting the merchant 102 to stop the transaction.

Similar transactions are generally repeatedly in the system 100 for the same and different merchants, in one form or another, multiple times (e.g., hundreds, thousands, hundreds of thousands, millions, etc. of times, etc.) per day (e.g., depending on the particular payment network and/or payment accounts involved, etc.), and with the transactions involving numerous consumers, merchants, acquirers and issuers.

In connection with the above example transaction (and such similar transactions), transaction data is generated, collected, and stored as part of the above exemplary interactions among the merchant 102, the acquirer 104, the payment network 106, the issuer 108, and the consumer. The transaction data represents at least a plurality of transactions including, for example, authorized transactions, cleared transactions, attempted transactions, etc. The transaction data, in this exemplary embodiment, is stored at least by the payment network 106 (e.g., in data structure 116, in other data structures associated with the payment network 106, etc.). The transaction data includes, for example (and without limitation), payment instrument identifiers such as payment account numbers, amounts of the transactions, merchant IDs, merchant category codes (MCCs), dates/times of the transactions, products purchased and related descriptions or identifiers, etc. It should be appreciated that more or less information related to transactions, as part of either authorization, clearing, and/or settling, may be included in transaction data and stored within the system 100, at the merchant 102, the acquirer 104, the payment network 106, and/or the issuer 108.

The transaction data described above will also often include a region, location, or designation of the merchant 102 (or other merchant) involved in the transaction. The region indicator may include, for example, a postal code, a city, a state, an area code, or other designation of the region location. As shown in FIG. 1, three regions are illustrated and referenced generally 112a-c. In this exemplary embodiment, the regions 112a-c represent locations having different postal codes. Moreover, each of the regions 112a-c includes various different merchants, along with the merchant 102 (in region 112c), as identified by dots in the regions 112a-c. Consequently, the transaction data for a given transaction (in this example embodiment) will include a postal code for the merchant involved in the transaction, which includes, in turn, one of the regions 112a-c illustrated in FIG. 1. Exemplary transaction data is illustrated in Table 1 for a number of example transactions in the system 100 (e.g., as stored in the data structure 116, etc.). As shown, the transaction data includes, for instance, an account number or PAN (primary account number) for the payment account used in the transaction, an amount of the transaction, a merchant identifier, and a region of the transaction.

TABLE 1

| PAN | Amount | Merchant ID | Region |
|---|---|---|---|
| 123456 | $13.54 | 156987 | 112a |
| 123456 | $15.87 | 695874 | 112b |
| 123457 | $64.12 | 156987 | 112a |
| 123456 | $25.13 | 695324 | 112c |
| 185241 | $125.36 | 456892 | 112c |
| 965487 | $48.25 | 457293 | 112b |

It should be appreciated that the transaction data included in Table 1 is merely exemplary in nature. It should further be appreciated that for a given region, numerous transactions will be initiated, whereby the transaction data will include transactions for hundreds, thousands, or tens of thousands of users or more or less, at hundreds or thousands of merchants, or more or less, in the regions. And, while one merchant 102, one acquirer 104, one payment network 106, and one issuer 108 are illustrated in the system 100 in FIG. 1, it should be appreciated that any number of these entities (and their associated components) may be included in the system 100, or may be included as a part of systems in other embodiments, consistent with the present disclosure.

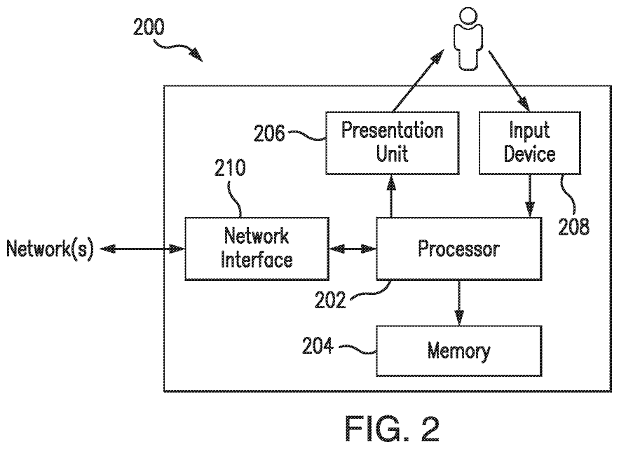

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, and the issuer 108 may include and/or may be implemented in or associated with, a computing device 200, coupled to one or more of the networks described above. Further, the computing device 200 associated with each of these parts of the system 100, for example, may include a single computing device, or multiple computing devices located in close proximity or distributed over a geographic region, again so long as the computing devices are specifically configured to function as described herein.

Referring to FIG. 2, the exemplary computing device 200 includes a processor 202 and a memory 204 coupled to (and in communication with) the processor 202. The processor 202 may include one or more processing units (e.g., in a multi-core configuration, etc.) such as, and without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, lists of entities (e.g., billers, etc.), lists of regions, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein (e.g., one or more of the operations of method 300, etc.), whereby the computing device 200 may be transformed into a special-purpose computing device (as indicated below). It should be appreciated that the memory 204 may include a variety of different memories, each implemented in one or more of the functions or processes described herein.

In the exemplary embodiment, the computing device 200 includes a presentation unit 206 that is coupled to (and that is in communication with) the processor 202 (however, it should be appreciated that the computing device 200 could include output devices other than the presentation unit 206, etc. in other embodiments). The presentation unit 206 outputs information, either visually or audibly to a user of the computing device 200 (such as the user 110, a user associated with the issuer 108, etc.), such as, for example, listings of local recurring billers, etc. Various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, another computing device, etc. In some embodiments, presentation unit 206 may include multiple devices.

The computing device 200 also includes an input device 208 that receives inputs from the user (i.e., user inputs), for example, relating to a listing of local recurring billers, relating to setup of electronic billing, etc. The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks described herein. Further, in some exemplary embodiments, the computing device 200 may include the processor 202 and one or more network interfaces incorporated into or with the processor 202.

Referring again to FIG. 1, the system 100 includes a data processor 114, which is specifically configured, by executable instructions, to perform one or more of the operations, as described herein. As shown in FIG. 1, the data processor 114 is illustrated generally as a standalone part of the system 100 in communication with the payment network 106. However, it should be appreciated that in some embodiments the data processor may be incorporated with or associated with the payment network 106, as desired (e.g., in one or more computing devices 200 associated with the payment network 106, etc.). Alternatively, in other embodiments, the data processor 114 may be incorporated in whole or in part with other parts of the system 100 (e.g., the issuer 108, etc.). In addition, the data processor 114 may be implemented in the system 100 in a computing device consistent with computing device 200, or in other computing devices within the scope of the present disclosure. That said, it should be appreciated that the data processor 114 will typically be employed at locations in the system 100 (or other systems) that allow for access to the transaction data, either as a standalone part of the system 100 or with another part of the system 100 involved (or not involved) in the underlying transaction(s) represented by the transaction data (e.g., the data processor 114 may be located at parts of the system 100 that are not involved in authorization, clearing, settlement, etc.).

The system 100 also includes the data structure 116 associated with the data processor 114. As described above, the data structure 116 includes a variety of different transaction data for different payment accounts, such as illustrated in Table 1. Similar to the data processor 114, the data structure 116 is illustrated as a standalone part of the system 100 (e.g., embodied in a computing device similar to computing device 200, etc.). However, in other embodiments, the data structure 116 may be included or integrated, in whole or in part, with the data processor 114, or with other parts of the system 100 (e.g., in the payment network 106 in a computing device 200 associated therewith, etc.).

With that said, in operation in the system 100, the data processor 114 is configured to receive a request for local recurring billers in a specific region, such as, for example, the region 112b (e.g., a target region, etc.). What's more, the request may originate from an entity, such as the issuer 108, which offers bill pay services for the user 110 via one or more accounts issued to the user 110 by the issuer 108 (e.g., in general such that the entity has the list available for users, or in response to a particular request by a user to set up a recurring bill payment, etc.).

In response, the data processor 114 is configured to access the transaction data, in the data structure 116, which is specific to the identified region 112b, or more broadly, to the user 112 as associated with (or likely associated with) the region 112b. In particular, the data processor 114 is configured to access transaction data for each of multiple payment accounts that are associated with transactions in the region 112b e.g., the payment account associated with the PAN 123456 in Table 1, etc.). Thereafter, the data processor 114 is configured to identify (probabilistically) a local region (e.g., a home region where the user associated with the payment account resides, etc.) of each of the payment accounts. Specifically, the data processor 114 is configured to segregate the transaction data for each of the payment accounts by region, whereby a count or number of the transactions associated with the payment account is identified to region 112a, and also to the region 112b and the region 112c. The data processor 114 is configured to then select the region in which a highest number of transactions occurred as the local region for the given payment account. The data processor 114 is configured to then identify recurring billers within the region 112b for each of the payment accounts, based on repetition of transactions with a given biller and a category of the given merchant (e.g., MCC, etc.). In addition to MCC (or as an alternative thereto), the data processor 114 may be configured to identify recurring billers based on periodic payments, etc.

Additionally, the data processor 114 is further configured to access data from the data structure 116 for the region 112b in general and identify local recurring billers therefor. In so doing, the data processor 114 is configured to identify recurring billers located within the region 112b, in general, based on repetition of transactions with a given biller and a category of the given merchant (e.g., MCC, etc.). In addition to MCC, the data processor 114 may be configured to access data for payment accounts identified to the region 112b, as explained above, and to identify billers based on periodic payments from users within the region (and/or based on category), as potential local recurring billers, which are not identified as local billers through the region indicated in the transaction data. For example, a streaming service biller may be located in one region (e.g., not region 112b, etc.), yet may provide service to a number of users in a different region (e.g., in region 112b, etc.). In this way, transactions by a consumer with a merchant that is identified as being outside of a local region of the consumer's payment account may still be identified as a local biller for that region, based on the recurring transactions to the consumer's payment account and/or based on multiple similar transactions to multiple different payment accounts already identified to the local region.

When all of the potential local recurring billers are identified, the data processor 114 is configured to filter or screen for outlier. For example, the data processor 114 may exclude duplicate merchants identified in the different manners described above, exclude merchants with miscoded MCCs, etc. In doing so, the data processor 114 may include (or may be associated with) a textual similarity engine configured to call out such duplicate merchants and/or a repository (or other data structure) of miscoded merchants to exclude those with miscoded MCCs and other irrelevant outcomes.

The data processor 114 is configured to then return the list of potential local recurring billers to the entity and/or requestor (e.g., the issuer 108, etc.) for use as described herein.

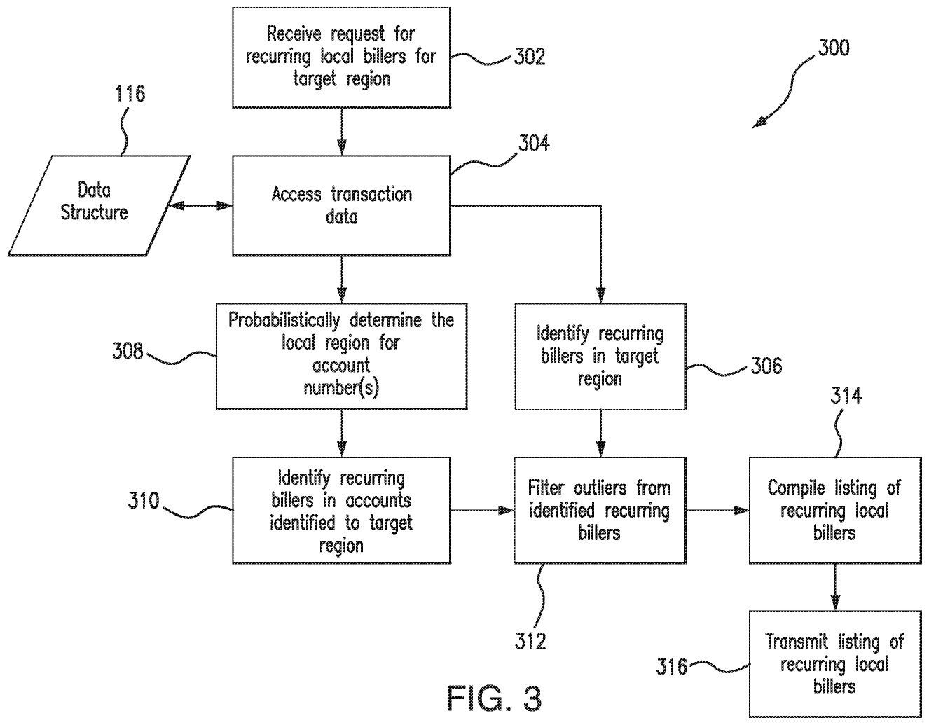

FIG. 3 illustrates an exemplary method 300 for identifying one or more recurring local billers for a target region, in response to a request specific to the target region. The exemplary method 300 is described as implemented in the data processor 114 and the data structure 116 of the system 110, with additional reference to the computing device 200. However, it should be understood that the method 300 is not limited to the above-described configuration of the system 100 or the computing device 200. Likewise, the systems and the computing devices herein should not be understood to be limited to the exemplary method 300.

At the outset in method 300, an entity submits a request (to the data processor 114) to identify recurring local billers for a target region, such as, for example, a specific postal code, area code, etc. In particular, when the entity is a financial institution (e.g., a bank, issuer 108, etc.), it may offer a bill pay service to its customers (e.g., the user 110, etc.). In such instances, in connection with providing the bill pay service, the entity is required to collect identifying information for billers, sufficient to initiate transactions to the billers to satisfy bills for its customers as part of the bill pay service. Preferably, the entity would pre-identify the billers, to thereby alleviate issues with subsequently identifying the billers based on information provided from the customers, which may be incomplete or inaccurate. As such, as described herein, the entity submits the request to the data processor 114 to identify recurring local billers for a target region in order to pre-identify the potential billers for the region.

In connection therewith, the data processor 114 receives the request from the entity, at 302. As noted above, the request includes an indication of the target region, such as, for example, a postal code, which is often a local region of a user (such as user 110) interacting with the entity (such as the issuer 108) to set up the bill pay service (e.g., a recurring payment, etc.). In turn, the data processor 114 accesses, at 304, the data structure 116 and, in particular, transaction data therein for multiple transactions. The transaction data, which is accessed, is initially specific to (or limited to or filtered to) the target region identified in the request (i.e., transactions represented by the transaction data including an identifier for the target region).

The data processor 114 then identifies, from the accessed transaction data, recurring local billers in the target region, at 306, based on periodic transactions to the billers (e.g., per payment account or otherwise, etc.), a frequency of transactions to the billers, and/or an amount of transactions to the billers, etc. It should be appreciated that when a transaction is executed on the 10th of each month for $15.37, it is likely a transaction involving a recurring biller. The identification of the recurring biller may be further based on a category associated with the biller/merchant, such as, for example, a MCC, etc. Specifically, certain MCCs are specific to recurring billers, such as, for example, MCC 4900 for utilities (e.g., Electric, Gas, Heating, Sanitary, Water, etc.), MCC 4899 for television and radio services (e.g., Cable, Satellite, and Other Pay Televisions and Radio Services, etc.), and MCC 4818 for phone services (e.g., Telecommunication Services including but not limited to prepaid phone services and recurring phone services; etc.), etc. What's more, the identification may be performed at the account level (i.e., per payment account), or more generally on the transaction data accessed from the data structure 116 (for all payment accounts involved in the underlying transactions).

The data processor 114 additionally determines, probabilistically, at 308, the local region of each payment account included in the data structure 116, or at least, in one embodiment, the payment accounts which include transactions in the target region (e.g., at the same time as 308, prior to 308, subsequent to 308, etc.). Specifically, the data processor 114 segregates the transactions for each payment account by region of the merchants involved in the transactions. As shown in Table 1, for example, the transaction data includes a region identifier for each transaction, which is often the region identifier associated with the merchant (e.g., the merchant 102, etc.) involved in the transaction, for example, which is programmed in a point-of-sale (POS) terminal at the merchant and passed to the acquirer 104, as described above, as part of the authorization request. In general, the region identifier indicates the region in which the merchant is located, but occasionally will identify an address associated with the merchant (e.g., a headquarters or corporate office of a merchant, etc.), but not the physical location of the merchant location at which the transaction actually occurred.

Next, a count of the transactions per region is compiled for a defined interval (e.g., a month, multiple months, year, etc.) (e.g., a most recent interval, etc.) for each of the payment accounts. The data processor 114 then determines a percentage of the transactions in each of the regions and identifies the local region of the payment account as the region with the highest percentage of transactions. In connection therewith, it should be appreciated that the identification may be based on a fixed threshold, whereby the region with the highest percentage (or number) of transactions is identified as the local region of the payment account. Alternatively, in various embodiments, such identification may not be based on a fixed threshold of percentages (or numbers). Instead, in such embodiments, the identification may be based on a frequency (or, possibly, a rate, etc.) of transactions for a payment account in a given region (e.g., as calculated for a defined interval, etc.).

It should be appreciated that the probabilistic determination may be done prior to the receipt of a request on an on-going or periodic basis, whereby the payment accounts are identified to local regions for efficiency in the method 300 and other data processing operations.

After the local region of each payment account is determined, the data processor 114 identifies, at 310, recurring billers from the account(s) identified to the target region. As above, the identification of the recurring billers may be based on periodic transactions, transaction frequency, transaction amount, etc. In addition, the identification of the recurring billers may be further based on a number of transactions in the target region in a given interval. Specifically, a frequency of transactions to a specific biller in a region, or a percentage relative to other billers, may be relied on to identify the billers as recurring billers. As an example, cable/streaming service transactions may be filtered by means of a relevant MCC code for a given zip code, and the resulting data may then be sorted based on frequency of transactions for each merchant to identify the top billers. As a another example, non-local merchant transactions for telecommunication services (e.g., as associated with AT&T, Sprint, Verizon, etc.) may be sorted based on a number of transaction for each zip code to identify a top provider in the zip code. In so doing, Sprint may have a significant presence in a first region but not in a second region (suggesting that Sprint is a recurring biller in the first region). . . ). In this way, transactions by a consumer with a merchant that is identified as being potentially outside of the target region of the consumer's payment account (e.g., at 306 based on an address of the merchant, etc.) may still be identified as a local biller for the target region, based on the recurring transactions to the consumer's payment account and/or based on multiple similar transactions to multiple different payment accounts already identified to the target region (e.g., at 308, etc.).

Thereafter, the identified recurring billers from 306 and 310 are combined by the data processor 114. The data processor 114 then filters, at 312, the identified recurring billers for outliers. For example, the data processor 114 may exclude duplicate merchants identified in the different manners described above, exclude merchants with miscoded MCCs, etc. In doing so, the data processor 114 may include (or may be associated with) a textual similarity engine configured to call out such duplicate merchants and/or a repository (or other data structure) of miscoded merchants to exclude those with miscoded MCCs and other irrelevant outcomes.

Once outliers are filtered out, the data processor 114 compiles, at 314, a listing of identified recurring local billers. In particular, the data processor 114 orchestrates and categorizes top identified merchants, per MCC and/or zip code. The data processor 114 then transmits, at 316, the listing of recurring local billers to the entity, in response to the request. In various embodiments, the data processor 114 may also transmit account data for the identified local billers to the entity, for use by the entity in establish new bill pay entries for users, etc.

In turn, the entity offers the recurring local billers to the user 110, for example, for selection in setting up the bill pay service for the entity. In connection therewith, any necessary account data for the user's account may be provided by the user 110 and/or the entity offering the bill pay service.

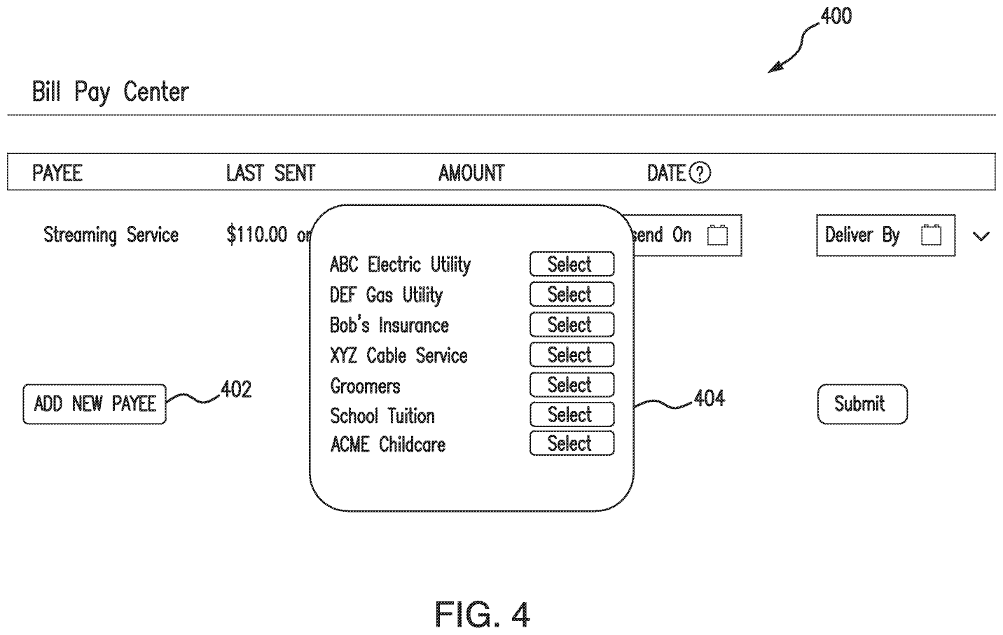

FIG. 4 illustrates an exemplary interface 400, which may be displayed, in some embodiments, to the user 110 via a website or network-enabled application to the user 110 at a communication device associated with the user 110 (e.g., a smartphone, tablet, laptop, personal computer, etc.) in connection with setting up the bill pay service. Specifically, as shown, when the user 110 accesses a website associated with the entity, the user 110 is able to access a bill pay center associated with the user's payment account (e.g., his/her checking account, etc.). When the user 110 selects an “Add New Payee” button 402, a light box 404 is displayed (e.g., overlaid on the interface 400 as shown in FIG. 4, etc.), which includes the listing of identified recurring local bills for the user 110, as received from the data processor 114. It should be appreciated that the request sent by the entity and received by the data processor 114, may be sent in response to the selection of the “Add New Payee” button 402 or prior. Regardless, the user 110 is then able to select the biller, whereby billing data associated with the biller is integrated into the user' bill pay center to set up single or recurring payment to the biller with no or limited input from the user 110.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a request for identification of recurring local entities (e.g., billers, etc.) for a target region; (b) accessing, by a computing device, data (e.g., transaction data, etc.) associated with the target region for multiple accounts (e.g., payment accounts, etc.), the data representative of multiple transactions and multiple accounts, each transaction having an account number associated with a user and a region identifier associated with an entity involved in the transaction; (c) determining, by the computing device, a local region for each of the accounts included in the data; (d) for each determined local region that is the same as the target region, identifying, by the computing device, one or more recurring entities from the transactions to said accounts having the determined local region; (e) compiling, by the computing device, a listing of recurring local entities including the identified one or more recurring entities; (f) identifying one or more additional recurring entities based on the accessed data and a category (e.g., a merchant category code (MCC), etc.) of the one or more additional entities; and (g) compiling the listing of recurring local entities to further include the one or more additional recurring entities.

Exemplary embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying one or more recurring local entities for a target region in response to a request specific to the target region, the method comprising:
receiving a request for identification of recurring local entities for a target region;
accessing, by a computing device, data associated with the target region for multiple accounts, the data representative of multiple network transactions and multiple accounts, each network transaction having an account number associated with a user and a region identifier associated with an entity involved in the network transaction;
determining, by the computing device, a local region for each of the accounts included in the data;
for each determined local region that is the same as the target region, identifying, by the computing device, one or more recurring entities from the network transactions to said accounts having the determined local region; and
compiling, by the computing device, a listing of recurring local entities including the identified one or more recurring entities.

2. The computer-implemented method of claim 1, wherein identifying the one or more recurring entities is based on a category of the one or more recurring entities.

3. The computer-implemented method of claim 2, wherein the category includes a merchant category code (MCC).

4. The computer-implemented method of claim 2, wherein identifying the one or more recurring entities is further based on a periodic occurrence and/or a frequency of transactions to the one or more recurring entities in the accounts.

5. The computer-implemented method of claim 1, further comprising identifying one or more additional recurring entities based on the accessed data and a category of the one or more additional entities; and
compiling the listing of recurring local entities to further include the one or more additional recurring entities.

6. The computer-implemented method of claim 5, further comprising filtering the one or more recurring entities and the one or more additional recurring entities for outliers, prior to compiling the listing; and
wherein compiling the listing includes compiling the listing to include the filtered one or more recurring entities and one or more additional recurring entities.

7. The computer-implemented method of claim 1, further comprising transmitting the listing of recurring local entities to a party that transmitted the request.

8. The computer-implemented method of claim 1, wherein the listing of recurring local entities includes a listing of recurring local billers for the target region; and
wherein the method further comprises transmitting the listing of recurring local billers to a party that transmitted the request, thereby allowing the party to display the listing of recurring local billers to a user in connection with a bill pay service associated with the party.

9. A non-transitory computer-readable storage medium including executable instructions for identifying recurring billers in a target region, which when executed by at least one processor, cause the at least one processor to:
access transaction data associated with a target region for multiple payment accounts in response to a request by an entity, the transaction data representative of multiple transactions and multiple payment accounts, each transaction having an account number associated with a user and a region identifier associated with a biller involved in the transaction;
determine a local region for each of the payment accounts included in the transaction data; for each determined local region that is the same as the target region, identify one or more recurring billers from the transactions to said payment accounts having the determined local region;
identify one or more additional recurring billers based on the accessed transaction data and a merchant category code (MCC) of the one or more additional billers; and
compile a listing of recurring local billers including the identified one or more recurring billers and the one or more additional recurring billers.

10. The non-transitory computer-readable storage medium of claim 9, wherein the executable instructions, when executed by the at least one processor, further cause the at least one processor to filter the one or more recurring billers and the one or more additional recurring billers for outliers, prior to compiling the listing; and
wherein the executable instructions, when executed by the at least one processor to compile the listing of recurring local billers, further cause the at least one processor to compile the listing to include the filtered one or more recurring billers and one or more additional recurring billers.

11. The non-transitory computer-readable storage medium of claim 10, wherein the executable instructions, when executed by the at least one processor to identify the one or more recurring billers, further cause the at least one processor to identify the one or more recurring billers based on a merchant category code (MCC) of the one or more recurring billers.

12. The non-transitory computer-readable storage medium of claim 11, wherein the executable instructions, when executed by the at least one processor to identify the one or more recurring billers, further cause the at least one processor to identify the one or more recurring billers based on a periodic occurrence and/or a frequency of transactions to the one or more recurring billers in the payment accounts.

13. The non-transitory computer-readable storage medium of claim 9, wherein the executable instructions, when executed by the at least one processor, further cause the at least one processor to transmit the listing of recurring local billers to the entity that transmitted the request.

14. A payment network for processing transactions between users and merchants, the payment network comprising at least one computing device configured to:
receive a request for identification of recurring local billers for a target region;
access transaction data associated with the target region for multiple payment accounts, the transaction data representative of multiple transactions and multiple payment accounts, each transaction having an account number associated with a user and a region identifier associated with a biller involved in the transaction;
determine a local region for each of the payment accounts included in the transaction data;
for each determined local region that is the same as the target region, identify one or more recurring billers from the transactions to said payment accounts having the determined local region;
compile a listing of recurring local billers including the identified one or more recurring billers; and
transmit the listing of recurring local billers to an entity that transmitted the request, whereby the entity displays the listing of recurring local billers to a user for selection of one or more of the recurring local billers from the listing in connection with a bill pay service associated with the entity.

15. The payment network of claim 14, wherein the at least one computing device is further configured to identify one or more additional recurring billers based on the accessed transaction data and a merchant category code (MCC) of the one or more additional billers; and
wherein the at least one computing device is configured, in connection with compiling the listing of recurring local billers, to compile the listing of recurring local billers to include the identified one or more recurring billers and the identified one or more additional recurring billers.

16. The payment network of claim 15, wherein the at least one computing device is further configured to filter the one or more identified recurring billers and the one or more identified additional recurring billers for outliers, prior to compiling the listing; and
wherein the at least one computing device is configured, in connection with compiling the listing of recurring local billers, to compile the listing of recurring local billers to include the filtered one or more recurring billers and one or more additional recurring billers.
